(19) United States
(12) Patent Application Publication
(10) Pub. No.: US 2017/0100222 A1
(43) Pub. Date: Apr. 13, 2017

(54) INTERCONNECTED DENTAL FLOSSERS

(71) Applicant: LeedTech Resources Company, LLC, Naperville, IL (US)

(72) Inventor: Russell G. Kalbfeld, Naperville, IL (US)

(21) Appl. No.: 15/286,886

(22) Filed: Oct. 6, 2016

Related U.S. Application Data
(60) Provisional application No. 62/238,679, filed on Oct. 7, 2015.

(51) Int. Cl. A61C 15/04; A61C 15/02

(52) U.S. Cl. CPC A61C 15/046; A61C 15/02; B29C 2045/2683

(57) ABSTRACT

A set of dental flossers includes a plurality of interconnected flossers. Each flosser includes a handle portion and a yoke portion. The handle portion of each flosser includes a first edge and a second edge. The first edge of each flosser is coupled to the first edge of an adjacent flosser by at least one first connecting member. Two of the flossers comprise end flossers, and the second edge of each of the plurality of flossers except for the end flossers is coupled to the second edge of an adjacent flosser by at least one second connecting member.

### CROSS-REFERENCE TO RELATED APPLICATION

This application claims the benefit of and priority to U.S. Provisional Patent Application No. 62/238,679, filed Oct. 7, 2015, the entire contents of which are hereby incorporated by reference.

### BACKGROUND

The present disclosure relates to dental care implements and more particularly to dental flossers.

Dental flossers are known for simplifying the task of flossing teeth. One type of known dental flosser is generally F-shaped and includes an elongated handle and a pair of arms or forks between which a length of dental floss extends. The handles and forks of these flossers are typically over molded onto a length of floss to provide an integral, single-use dental flosser.

Standard injection molding manufacturing techniques for single-use flossers produce large batches of loose, individual flossers. Because of their relatively light but somewhat variable weight, in many instances reliably packaging large numbers of individual flossers into a single package involves manually counting the flossers. Often batches of flossers are loosely packaged, for example in a batch of 100 flossers, within a flexible bag, which is often resealable. Over time flossers packaged in this manner can become entangled with one another, making removal of an individual flosser difficult.

Accordingly, there is a need for improvements in flosser design that facilitate one or more of efficient manufacturing processes, easier packaging, and more convenient dispensing of individual flossers.

### SUMMARY

In some aspects, a set of dental flossers includes a plurality of flossers, each flosser includes a handle portion and a yoke portion. The handle portion of each flosser includes a first edge and a second edge. The first edge of each flosser is coupled to the first edge of an adjacent flosser by at least one first connecting member. Two of the flossers comprise end flossers, and the second edge of each of the plurality of flossers except for the end flossers is coupled to the second edge of an adjacent flosser by at least one second connecting member.

Each flosser in the set may be substantially identical to the other flossers in the set. At least one of the first edge and second edge of each flosser may be substantially straight. The handle portion of each flosser may be substantially triangular. Each yoke portion may support a respective length of floss. Each length of floss may be substantially parallel to the other lengths of floss. A first reference line extending generally in a direction of the first edges may define an angle A with respect to a second reference line extending generally parallel to the lengths of floss, and a third reference line extending generally in a direction of the second edges may define an angle B with the second reference line. The angle A may be less than the angle B. The yoke portion of each flosser may include a proximal arm and a distal arm, and the length of floss of each flosser may extend between the proximal arm and the distal arm of its respective yoke. Each first edge may extend generally toward the distal arm of its respective flosser, and each second edge may extend generally toward the proximal arm of its respective flosser. The first and second connecting members may be breakable by bending each flosser relative to one of its adjacent flossers. Two first connecting members may connect each coupled pair of first edges to one another, and two second connecting members may connect each coupled pair of second edges to one another. The set may be integrally molded and formed of a single piece of injection molded plastic. Each first connecting member may be located a distance from a nearest end of the first edge to which it is attached that is between about 20% and about 45% of a length of the first edge to which it is attached.

In other aspects, a set of dental flossers includes a first group of dental flossers oriented in a first direction. Each flosser in the first group of flossers includes a length of floss, and each length of floss in the first group of flossers is substantially collinear with the other lengths of floss in the first group of flossers. The set also includes a second group of dental flossers oriented in a second direction and coupled to the first group of dental flossers. Each flosser in the second group of flossers includes a length of floss, and each length of floss in the second group of flossers is substantially collinear with the other lengths of floss in the first group of flossers.

The lengths of floss in the first group of flossers may be substantially parallel to the lengths of floss in the second group of flossers. Each flosser in the first group of flossers may be directly connected to at least one flosser in the second group of flossers by at least one connecting member. Each flosser may include a generally triangular handle portion and a yoke portion extending from the handle portion.

### BRIEF DESCRIPTION OF THE DRAWINGS

FIG. 1 is plan view of a set of ten interconnected dental flossers.

FIG. 2 is a plan view of a set of ten interconnected dental flossers inserted into a resealable bag.

FIG. 3 is a perspective view of a set of ten interconnected dental flossers being inserted into a resealable bag.

FIG. 4 is a perspective view of a set of ten interconnected dental flossers being inserted into a blister pack.

FIG. 5 is a perspective view of a set of ten interconnected dental flossers being inserted into a blister pack including a biasing portion that biases the dental flossers toward an opening of the blister pack.

FIG. 6 is a perspective view of a set of ten interconnected dental flossers being inserted into a blister pack including a ramp portion that urges the dental flossers toward an opening of the blister pack.

FIG. 7 is a perspective view of the blister pack of FIG. 6 with the set of ten interconnected dental flossers inserted therein and a backer board including a fold-away portion that defines the opening through which the dental flossers may be removed from the packaging.

FIG. 8 is a plan view of a set of four interconnected dental flossers illustrated various geometric parameters that may be used to design sets of interconnected dental flossers.

FIG. 9 is a plan view of a mold configuration for molding interconnected dental flossers in a standard injection molding machine.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

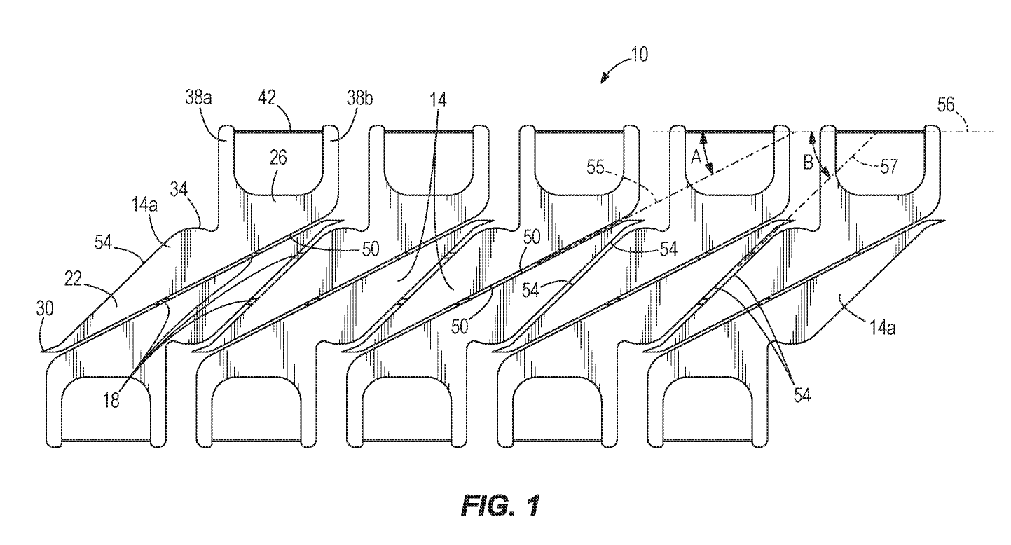

FIG. 1 illustrates a set 10 of interconnected interdental flossers 14. The illustrated exemplary set 10 includes ten interdental flossers 14 that are interconnected by connection members 18, described further below. Although the specific configuration of the interdental flossers 14 can vary, in the illustrated construction, each interdental flosser 14 includes a handle portion 22 and a yoke portion 26. The handle portion 22 includes a pick 30 formed at a proximal end thereof for removing plaque or other debris from the gum line or interdental spaces of a user. The handle portion 22 also includes an enlarged portion defining a grip member 34 at a distal end thereof. The yoke portion 26 extends from the distal end of the handle portion 22 and includes a proximal arm 38a and a distal arm 38b arranged as a pair. Although other configurations are possible, in the illustrated configuration the arms 38a, 38b are substantially parallel and of substantially equal length. A length of floss 42 extends between the distal ends of the arms 38a, 38b.

The handle portions 22 of the flossers 14 in the set 10 are interconnected with one another by the connecting members 18. In the illustrated configuration, each flosser 14 is connected to at least one adjacent flosser 14 by at least one connecting member 18 that extends between the handle portions 22 of the respective flossers 14. More specifically, each handle portion 22 includes a first edge 50 extending substantially from the pick 30 toward the distal arm 38b, and a second edge 54 extending substantially from the pick 30 toward the proximal arm 38a. The flossers 14 in the exemplary illustrated configuration are arranged generally in a line and in an alternating or nested arrangement such that the first edge 50 of each flosser 14 is adjacent to the first edge 50 of an adjacent flosser 14 and, with the exception of the two end flossers 14a located at the ends of the set 10, the second edge 54 of each flosser 14 is adjacent the second edge 54 of its adjacent flosser 14. As a result, in the illustrated arrangement each flosser 14 except for the two end flossers 14a is interconnected with two adjacent flossers 14, one that is adjacent its first edge 50 and one that is adjacent its second edge 54. The illustrated alternating arrangement provides a first group of flossers 14 oriented in a first direction and having lengths of floss 42 that are substantially collinear, and a second group of flossers 14 oriented in a second direction opposite the first direction and also having lengths of floss that are substantially collinear. The lengths of floss 42 of the first group and the lengths of floss 42 of the second group are substantially parallel. As a result, all of the lengths of floss 42 are substantially parallel with each other (with some of the lengths of floss 42 also being collinear with each other). In the illustrated configurations, the first and second edges 50, 54 are substantially straight, in other configurations the first and second edges 50, 54 may include non-straight features such as curves, waves, or angular features that are complimentary to one another to facilitate an alternating or nested arrangement.

While the first and second edges 50, 54 may take on a variety of configurations, the overall configuration of the illustrated handle portions 22 of each flosser 14 is generally triangular. This generally triangular shape, defined generally by the first and second edges 50, 54 and the base of the yoke portion 26, allows the handle portions 22 to include a pointed proximal end defining the pick 30, and an enlarged distal end that facilitates gripping and maneuvering of the flosser 14. The generally triangular shape also allows the flossers to nest closely together within a reduced footprint. In the illustrated configuration, and with reference to FIG. 1, a reference line 55 extending in the general direction of the first edges 50 defines an angle A with a reference line 56 extending generally parallel to the lengths of floss 42. Similarly, a reference line 57 extending in the general direction of the second edges 54 defines an angle B with the reference line 56 extending generally parallel to the lengths of floss 42. The angle A is less than the angle B.

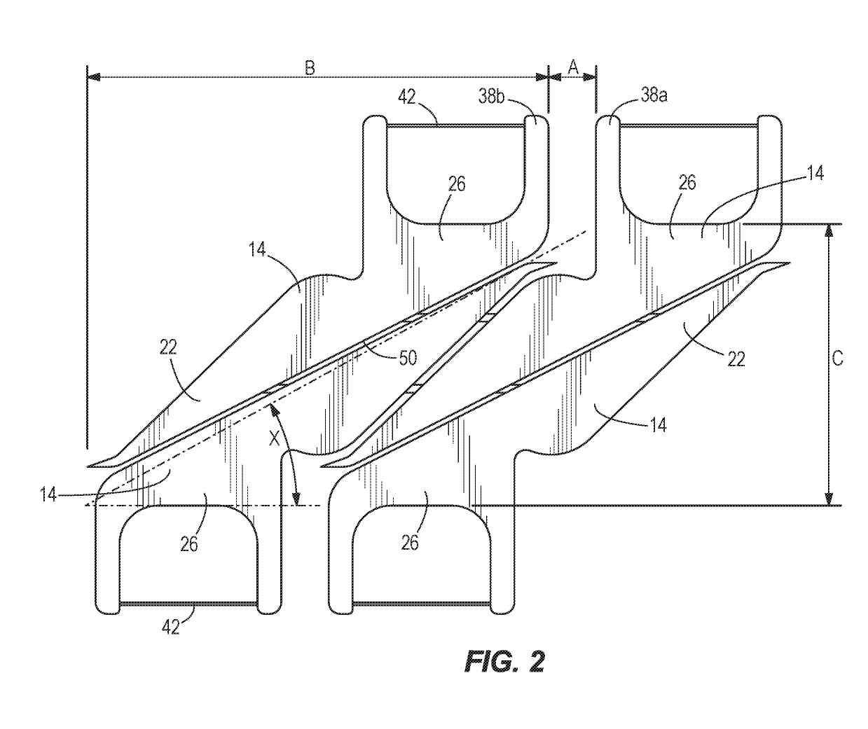

Referring also to FIG. 2, the nested arrangement of the flossers 14 can be defined by several parameters that may allow a designer to arrange the flossers 14 to fit within a desired footprint, for example to fit within standardized packaging, as discussed further below. For example, a flosser spacing distance A is defined as the distance between the distal arm 38b of one flosser 14 and the proximal arm 38a of an adjacent flosser. A flosser length B is defined as the distance from the pick 30 to the distal arm 38b of a given flosser 14 in a direction substantially parallel to the longitudinal extent of the length of floss 42 of the flosser 14. A yoke spacing distance C is defined as the distance from the base of the yoke portion 26 of one flosser 14 to the base of the yoke portion 26 of an adjacent flosser 14 in a direction substantially perpendicular to the longitudinal extent of the length of floss 42 of the flosser. A handle angle X is defined as the angle between the base of the yoke portion 26 of a flosser and the first edge 54 of the flosser 14. By adjusting these dimensions a designer can make the set 10 of flossers 14 wider and shorter or narrower and longer as desired.

The connecting members 18 are configured to be easily breakable by a user by bending a flosser 14 at the end of a set 10 relative to its adjacent flosser 14 about an axis substantially extending through the connecting members 18. For example, with reference to FIG. 1, bending either of the outer-most/end flossers 14 relative to their adjacent flossers will strain the coupling members 18 positioned along the first edges 50 of the adjacent flossers 14. After one or more bending cycles the coupling members 18 will break such that the flosser 14 becomes separated from the set 10 and may be individually used. In some embodiments the coupling members 18 are portions of plastic that are integrally molded with the flossers 14. Coupling members 18 may be less than about 3 mm wide and less than about 6 mm long, and may include localized reductions at a central portion of the coupling members 18 or at locations adjacent to the first or second edges 50, 54 of the flossers 14 to facilitate breakage of the coupling members 18.

Once a flosser 14 is separated from the set 10, all or a portion of one or both connecting members 18 may remain attached to the flosser 14. To reduce the likelihood of user discomfort as a result of the remains of a connecting member 18 contacting the soft tissues within the mouth, the connecting members 18 may be positioned at locations along the first or second edges 50, 54 that substantially coincide with where the user is likely to place his or her finger during a use. In this way, the user's finger covers the remains of the connecting member 18 and reduces the likelihood of the remains of the connecting member 18 contacting the inside of the user's mouth. In some exemplary embodiments, at least one of the connecting members 18 is located a distance from the nearest end of the first or second edge 50, 54 to which it is attached that is between about 20% and about 45% of the length of the first or second edge 50, 54 to which it is attached. In other exemplary embodiments, at least one of the connecting members 18 is located a distance from the nearest end of the first or second edge 50, 54 to which it is attached that is between about 25% and about 40% of the length of the first or second edge 50, 54 to which it is attached. In still other exemplary embodiments, at least one of the connecting members 18 is located a distance from the nearest end of the first or second edge 50, 54 to which it is attached that is between about 30% and about 35% of the length of the first or second edge 50, 54 to which it is attached. In still other exemplary embodiments, the connecting members 18 located on the first edge 50 are each located a distance from the nearest end of the first edge 50 that is between about 20% and about 45% of the length of the first edge 50. In still other exemplary embodiments, the connecting members 18 located on the second edge 54 are each located a distance from the nearest end of the second edge 54 that is between about 20% and about 45% of the length of the second edge 54.

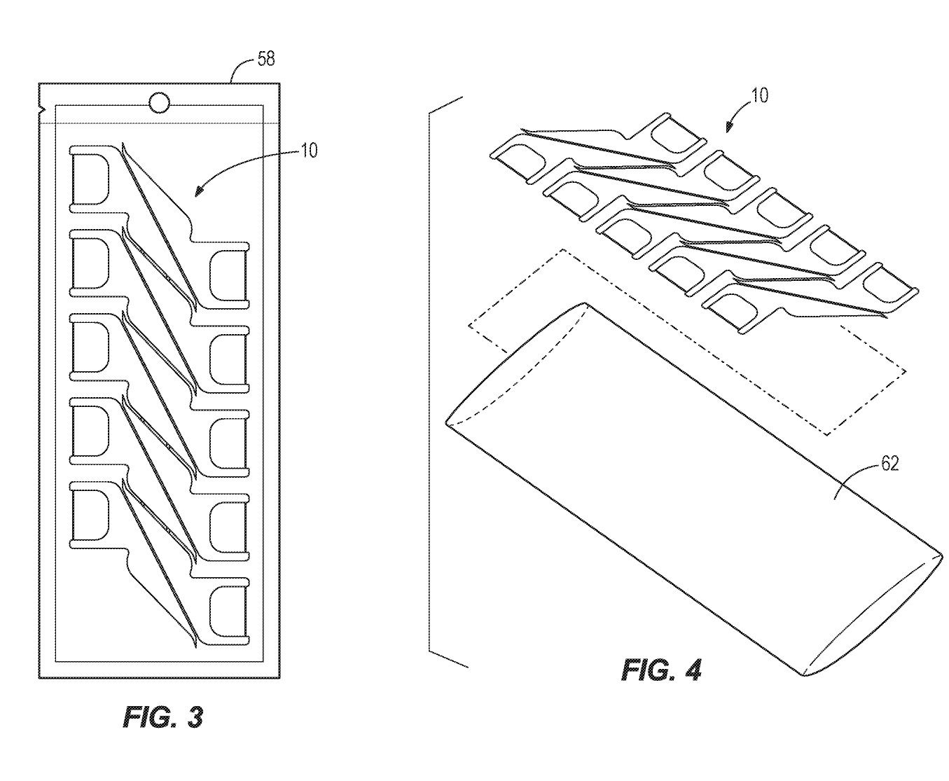

Referring also to FIGS. 3 and 4, by forming the flossers 14 as an integrated set 10, various packaging advantages may be realized. FIG. 3 illustrates the set 10 of flossers 14 inserted into a zip-top hanger bag 58. FIG. 4 illustrates the set 10 of flossers 14 being inserted into a fold-over or heat seal bag 62. Other types of bags may also be used in combination with one or more sets 10 of flossers 14 without departing from the spirit and scope of the present invention. Two or more sets 10 of flossers 14 may be included in a stacked arrangement in either the hanger bag 58 or the heat seal bag. In both cases, once the flossers 14 are inserted into the bag 58, 62, the flossers 14 remain neatly arranged, thereby providing a more appealing appearance on the shelf compared to individually packaged flossers that tend to tangle and collect at the bottom of the bag into which they are packaged. Because the flossers 14 remain attached to one another during packaging, it may be more efficient to automate packaging lines for sets 10 of flossers 14 compared to loose individual flossers. For example, whether done manually or with automated equipment, it will generally be easier to package nine sets 10 of flossers 14 to provide a package with ninety flossers than to package ninety individual flossers.

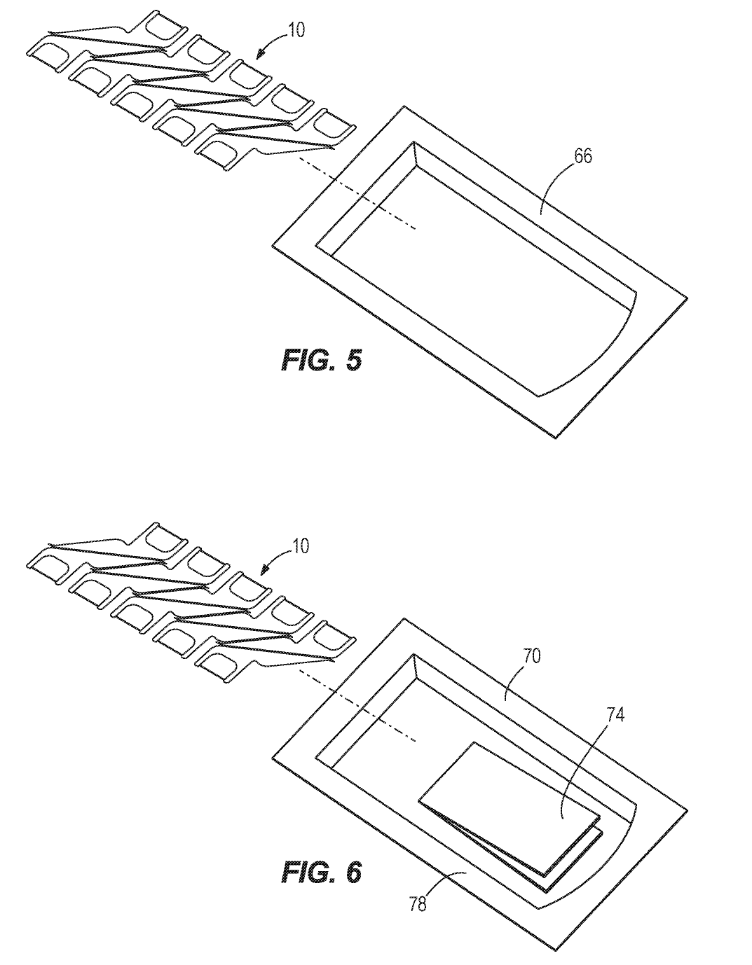

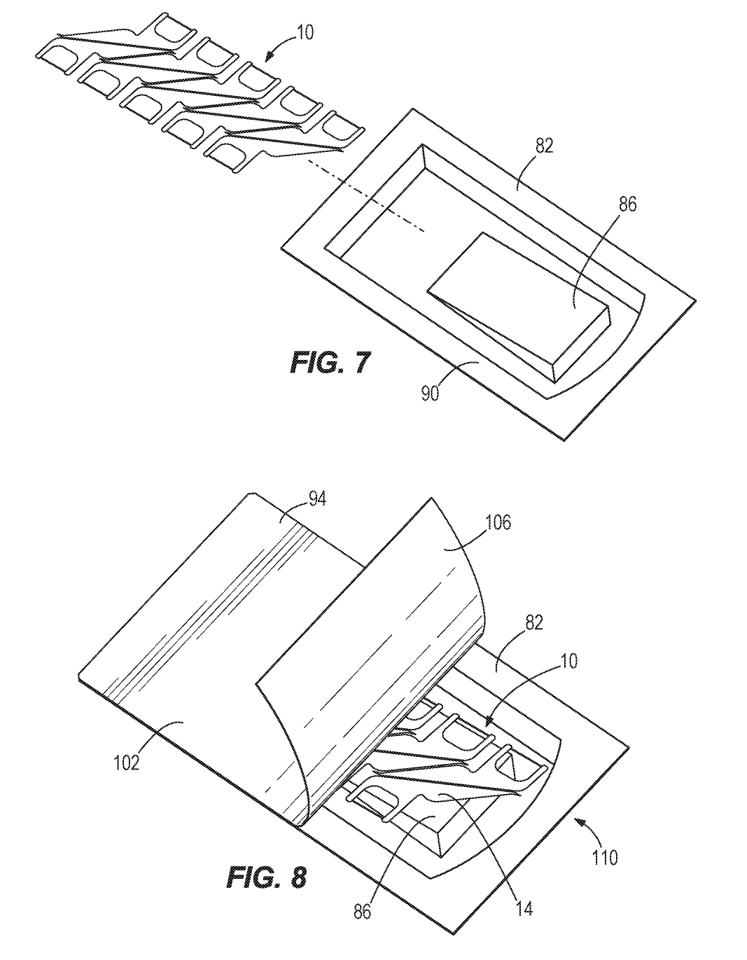

Referring also to FIGS. 5-8, various combinations of sets 10 of flossers 14 and different configurations of blister packs are illustrated. In FIG. 5, a set 10 of flossers 14 is shown in combination with a first blister pack 66 of a substantially conventional construction. In FIG. 6, a set 10 of flossers 14 is shown in combination with a second blister pack 70 that is provided with a resilient ramp member 74, which may be inserted into the blister pack 70 or formed integrally therewith. The ramp member 74 is configured to urge one end of the set 10 of flossers 14 generally away from a bottom panel 78 of the second blister pack 70, which may facilitate dispensing and removal of individual flossers 14 from the second blister pack 70, as discussed further below. FIG. 7 illustrates a set 10 of flossers 14 in combination with a third blister pack 82 provided with a substantially rigid ramp member 86 that may be inserted into the third blister pack 82 or formed integrally therewith. The rigid ramp member 86 is similar to the resilient ramp member 74 but is generally substantially completely fixed with respect to a bottom panel 90 of the third blister pack 82. The rigid ramp member 86 functions similarly to the resilient ramp member 74 by guiding the flossers 14 toward an opening in the third blister pack 82. In some applications the rigid ramp member 86 of the third blister pack 82 may be more efficiently manufactured than the resilient ramp member 74 of the second blister pack 70.

FIG. 8 illustrates the third blister pack 82 with a backer board 94 secured thereto and at least one set 10 of flossers inserted therein. The backer board 94 includes a fixed portion 102 secured to the blister pack 82 and a moveable portion 106 that is positioned above the rigid ramp member 86. The moveable portion 106 is movable between opened and closed positions (open position illustrated) to facilitate removal and storage of flossers 14. When in the opened position the moveable portion 106 cooperates with the blister pack 82 to define an opening 110 through which flossers 14 may be dispensed. As shown, the rigid ramp member 86 urges the flosser 14 nearest the opening 110 upwardly toward the opening, making the flosser 14 easier to grasp. A user seeking to remove one flosser 14 may grasp the end flosser 14 and bend it relative to its adjacent flosser 14 until the connection members 18 break, thereby freeing the flosser 14. While removing one flosser 14, the entire set generally will be moved outwardly toward the opening 106 such that after the end flosser 14 is removed, the new end flosser 14 is positioned near the opening 106 for easy grasping and removal. This process continues until all the flossers 14 in a set 10 are removed, at which point the flossers 14 in the next set 10 of flossers 14 (if present) will be exposed for subsequent removal. By removing flossers 14 in this manner, flossers 14 that are not intended to be used generally have very little contact with the user's hand, thereby improving sanitation relative to a package that includes a number of loose individual flossers. After the desired number of flossers 14 is removed from the blister pack 82, the moveable portion 106 of the backer board 94 may be moved to the closed position, thereby covering the flossers 10 and keeping them relatively clean.

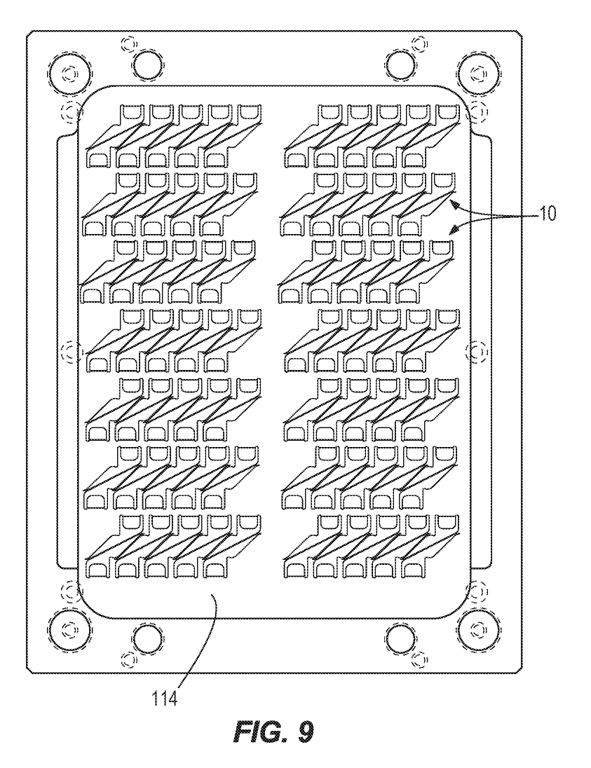

Referring also to FIG. 9, the nested configuration of the sets 10 of flossers 14 may allow for an increase in productivity relative to individually molded flossers formed in the same or similar injection molding equipment. In the configuration of FIG. 9, two columns and seven rows of sets 10 of ten flossers 14, are shown arranged within the footprint of a standard injection molding die 114. Thus, one-hundred and forty flossers 14, arranged in 14 sets of 10, may be formed with each cycle of the injection molding tool. When molding individual flossers in a similar injection molding die 114 prior art processes and arrangements of flossers result in about one-hundred individual flossers per cycle of the tool. Injection molding operations may be done in a horizontal or vertical injection molding system. Because the flossers 14 are integrally injection molded with one another in sets of 10, handling equipment for transferring flossers 14 from the injection molding tool to other downstream processes, such as floss cutting and/or floss flavoring, may be configured to transfer the flossers 14 as sets 10, which generally allows for the machinery to be simpler and more reliable than similar handling equipment configured to handle individual flossers.

Various features and advantages of the invention are set forth in the following claims.

What is claimed is:

1. A set of dental flossers comprising:
a plurality of flossers, each flosser including a handle portion and a yoke portion, the handle portion of each flosser including a first edge and a second edge, wherein the first edge of each flosser is coupled to the first edge of an adjacent flosser by at least one first connecting member, wherein two of the flossers comprise end flossers, and wherein the second edge of each of the plurality of flossers except the end flossers is coupled to the second edge of an adjacent flosser by at least one second connecting member.

2. The set of claim 1, wherein each flosser in the set is substantially identical to the other flossers in the set.

3. The set of claim 1, wherein at least one of the first edge and second edge of each flosser is substantially straight.

3. The set of claim 1, wherein the handle portion of each flosser is substantially triangular.

4. The set of claim 1, wherein each yoke portion supports a respective length of floss.

5. The set of claim 4, wherein each length of floss is substantially parallel to the other lengths of floss.

6. The set of claim 4, wherein a first reference line extending generally in a direction of the first edges defines an angle A with respect to a second reference line extending generally parallel to the lengths of floss, wherein a third reference line extending generally in a direction of the second edges defines an angle B with the second reference line, and wherein the angle A is less than the angle B.

7. The set of claim 4, wherein the yoke portion of each flosser includes a proximal arm and a distal arm, and wherein the length of floss of each flosser extends between the proximal arm and the distal arm of its respective yoke.

8. The set of claim 7, wherein each first edge extends generally toward the distal arm of its respective flosser, and wherein each second edge extends generally toward the proximal arm of its respective flosser.

9. The set of claim 1, wherein the first and second connecting members are breakable by bending each flosser relative to one of its adjacent flossers.

10. The set of claim 1, wherein two first connecting members connect each coupled pair of first edges to one another, and wherein two second connecting members connect each coupled pair of second edges to one another.

11. The set of claim 1, wherein the set is integrally molded and formed of a single piece of injection molded plastic.

12. The set of claim 1, wherein each first connecting member is located a distance from a nearest end of the first edge to which it is attached that is between about 20% and about 45% of a length of the first edge to which it is attached.

13. A set of dental flossers comprising:
a first group of dental flossers oriented in a first direction, each flosser in the first group of flossers including a length of floss, and each length of floss in the first group of flossers being substantially collinear with the other lengths of floss in the first group of flossers; and
a second group of dental flossers oriented in a second direction and coupled to the first group of dental flossers, each flosser in the second group of flossers including a length of floss, and each length of floss in the second group of flossers being substantially collinear with the other lengths of floss in the first group of flossers.

14. The set of dental flossers of claim 13, wherein the lengths of floss in the first group of flossers are substantially parallel to the lengths of floss in the second group of flossers.

15. The set of dental flossers of claim 13, wherein each flosser in the first group of flossers is directly connected to at least one flosser in the second group of flossers by at least one connecting member.

16. The set of dental flossers of claim 13, wherein each flosser includes a generally triangular handle portion and a yoke portion extending from the handle portion.
